(19) United States
(12) Patent Application Publication
(10) Pub. No.: US 2023/0164397 A1
(43) Pub. Date: May 25, 2023

(54) DISTRIBUTED ELECTION-BASED END-TO-END CONTENT DISTRIBUTION NETWORK SYSTEM AND DISTRIBUTION METHOD

(71) Applicant: Yang BAI, Shanghai (CN)

(72) Inventor: Yang BAI, Shanghai (CN)

(21) Appl. No.: 17/919,057

(22) PCT Filed: Apr. 8, 2021
(86) PCT No.: PCT/CN2021/085856

§ 371 Date: Oct. 14, 2022

(30) Foreign Application Priority Data
Apr. 21, 2020 (CN) 202010319391.9

(51) Int. Cl. H04N 21/63; H04N 21/845; H04N 21/443

(52) U.S. Cl. CPC H04N 21/632; H04N 21/845; H04N 21/4431

(57) ABSTRACT

A peer-to-peer content distribution network system based on distributed election includes a p2pcdn server cluster and a p2p client network. The p2pcdn server cluster includes any number of server nodes. The p2p client network includes any number of p2p client endpoints that need to use the peer-to-peer content distribution network. Each p2p client endpoint can establish a connection with the p2p server cluster on demand. The peer-to-peer content distribution network can make full use of the uploading capability of each user terminal equipment including mobile phones, tablets and PCs, so that each terminal equipment can communicate with each other, achieve real-time mutual sharing of resources and data, and form a new generation of p2p CDN network that “the more people who download, the faster the speed”.

### TECHNICAL FIELD

The present invention relates to the field of Internet, in particular to an end-to-end content distribution network system and distribution method based on distributed election.

### BACKGROUND

In the early stage of the Internet, most users obtained the required text, pictures, audio and video resources by directly accessing the server set up by the developer. As shown in FIG. 1, this long-distance, cross-operator (ISP) data communication method in the region has fatal shortcomings such as high delay, low throughput, high cost, and poor concurrency performance. As a result, the content provider (CP) has high operating costs such as bandwidth and traffic, and has poor user experience (slow and stuck). Therefore, there is this net phrase that most Chinese netizens are familiar with: “The farthest distance in the world is not the ends of the earth and the sea, but I am in china telecom, but you are in china mobile.” To alleviate the above problems, Content Delivery Network (CDN) technology came into being. CDN technology pulls data layer by layer from the source site. When a user requests these data, the data cache node that is close to the user and has the same ISP link as possible is used to provide data to the user. As shown in FIG. 2, this approach of “proximity provisioning” at both the geographic location and link (operator) level significantly improves the user experience. At the same time, it also effectively reduces the network traffic cost of CP (CDN traffic cost is mainly composed of two parts: distribution and back-to-source. On the whole, compared with before using CDN, the traffic cost can be reduced by as much as 40% after using CDN).

But for CP, CDN fees are still high. At the same time, during peak hours or for popular content, there are still obvious delays and freezes, and the user experience is not good.

To sum up, the existing CDN solutions still have two major problems:

1. High traffic costs: more users visit means more expensive traffic costs. In fact, traffic costs have become the main expenditure cost of various audio and video on-demand and live broadcast websites. According to reports, Youku's traffic cost in 2011 was as high as hundreds of millions of CNY; while YouTube's traffic cost in 2009 alone was as high as billions of USD.

2. Stuttering and poor user experience: More concurrent users means more people sharing limited bandwidth resources at the same time (the more people watching at the same time, the more stuck). Therefore, in the event of breaking video, hot file download, and major live broadcast or online game events, it is unavoidable to freeze, which greatly affects the user experience.

### SUMMARY

The purpose of the present invention is to provide an end-to-end content distribution network system and distribution method based on distributed election, which can make full use of the uploading capability of each user terminal equipment including mobile phones, tablets and PCs, and allow each terminal equipment communicate with each other. Achieve real-time mutual sharing of resources and data, and form a new generation of p2p CDN network that “the more people who download, the faster the speed”.

In order to achieve the above object, the technical scheme of the present invention is: A peer-to-peer content distribution network system based on distributed election, comprising a p2pcdn server cluster; the p2pcdn server cluster can include any number of server nodes; The p2pcdn server cluster divides each resource to be distributed or shared into data chunks, and selects respective owner server node for the data chunks in the p2pcdn server cluster by way of election, and the data chunk is used as a unit to perform peer-to-peer distribution or sharing of resources.

Further, within each p2pcdn server node, a corresponding owner process, owner thread or owner coroutine is elected for each of the data chunks belonging to the server node.

Further, the owner node of the data chunk, or its owner process, owner thread or owner coroutine is responsible for tracking, matching and coordinating various states of the data chunk.

A peer-to-peer content distribution network system based on distributed election, including a p2pcdn server cluster and a p2p client network; The p2pcdn server cluster may include any number of server nodes; The p2p client network includes any number of p2p client endpoints that need to use the peer-to-peer content distribution network, and each p2p client endpoint can establish a connection with the p2p server cluster as needed;

The p2pcdn server cluster provides the following API primitives: initialization (Init), receiving messages (message push, WaitMsg), subnet matching (requesting data chunks, AcquireChunk), sharing data chunks (OfferChunk), canceling data chunk sharing (RevokeChunk).

Further, the p2pcdn server cluster also provides the following API primitives: P2P connection initiation (p2pOffer), P2P connection response (p2pAnswer).

A distribution method for a peer-to-peer content distribution network system based on distributed election, wherein the p2pcdn server cluster processes requests from p2p client endpoints through the following steps:

Step 1. Wait and accept the next request sent by the p2p client;

Step 2. If the request is an “Init” API request, and the API request is not in a valid session context, create a new session for it and become the owner of the new session through election; If the API request is in a valid session, query the relevant information of the session in its owner node, and notify all the owner nodes of the data chunks currently being shared by the session to eliminate the session from the relevant records of the corresponding data chunks;

Step 3. If the request is a “WaitMsg” API request, push the message to the corresponding session through this call as needed;

Step 4. If the request is an “AcquireChunk” API request, match any number of eligible suppliers (donors) for the current session (as donee) with any given rule, and push the corresponding resource request (“Res.Req”) message to these donor endpoints;

Step 5. If the request is an “OfferChunk” API request, update and track the data chunk sharing status of the session on the owner node of the current session, and try to elect to become the owner node of these data chunks or notify their existing owner nodes, to add or update the newly added donor endpoint information to the relevant records of these data chunks;

Step 6. If the request is a “RevokeChunk” API request, update and track the data chunk sharing status of the session on the owner node of the current session. And notify the owner nodes of these data chunks to delete or eliminate the current session from the corresponding donor records of these data chunks;

Step 7. Jump back to step 1 (continue to process the next request).

Further, the p2p client accesses the p2pcdn server cluster through the following steps:

Step 1. Initialization: use the “Init” API to obtain or reset the session, and establish a message push connection through the “WaitMsg” API;

Step 2. For the resources on the current session, use the “AcquireChunk” API to request to obtain data chunks sharing from other p2p client endpoints, or obtain its data chunks separately through ordinary CDN, origin site or other traditional distribution channels;

Step 3. When receiving the p2p connection request message pushed by the p2pcdn server, try to establish a p2p connection with the specified donee endpoint, after the p2p subnet is successfully established, it can directly communicate with each donor endpoint in the subnet and receive the the contents of data chunks sent (shared) by them;

Step 4. Add the successfully obtained data chunks to the local cache, and publish these shares in real time or periodically through the “OfferChunk” API;

Step 5. Notify the p2pcdn server of the data chunks that can no longer be shared through the “RevokeChunk” API in real time or periodically to unshare these data chunks.

Further, the p2pcdn server cluster further includes the following steps after step 6:

Step 7. If the request is a “p2pOffer” API request, push the specified P2P connection establishment request message to the p2p client endpoint specified in the request;

Step 8. If the request is a “p2pAnswer” API request, push the specified P2P connection establishment response message to the p2p client endpoint specified in the request;

Step 9. Jump back to step 1 (continue to process the next request).

Further, the p2p client accesses the p2pcdn server cluster through the following steps:

Step 1. Initialization: use the “Init” API to obtain or reset the session, and establish a message push connection through the “WaitMsg” API;

Step 2. For the resources on the current session, use the “AcquireChunk” API to request to obtain data chunks sharing from other p2p client endpoints, or obtain its data chunks separately through ordinary CDN, origin site or other traditional distribution channels;

Step 3. When receiving the p2p connection request (“P2P.Offer”) message pushed by the p2pcdn server, call the “p2pAnswer” API to establish the p2p subnet. After the subnet is successfully established, it can directly communicate with each donor endpoint in the subnet and receive the contents of data chunks sent (shared) by them;

Step 4. Add the successfully obtained data chunks to the local cache, and publish these shares in real time or periodically through the “OfferChunk” API, and establish p2p subnets via the “p2pOffer” API in order to share them to other p2p client endpoints;

Step 5. Notify the p2pcdn server of the data chunks that can no longer be shared through the “RevokeChunk” API in real time or periodically to unshare these data chunks.

Step 6. When receiving the resource request (“Res.Req”) message pushed by the p2pcdn server, try to establish a p2p connection with the corresponding donee endpoint through the “p2pOffer” API, after the p2p connection is successful, the current p2p client endpoint (donor) can try to share its requested data chunks with the donee endpoint.

Further, “freewheeling” optimization can also be provided. After each successful establishment of a p2p subnet, the donee p2p client endpoint tries to continue to obtain other adjacent data chunks required from the p2p subnet that has been successfully established.

Advantages of the present invention relative to the prior art:

The present invention can share the data that everyone has downloaded in real time to nearby “neighbor nodes” with the same needs. At the same time, it also obtains the data shared by neighbor nodes. For users, it is no longer stuck, and the experience is greatly improved; Saves expensive traffic for CP and significantly reduces operating expenses.

### BRIEF DESCRIPTION OF DRAWINGS

FIG. 1 is a schematic structural diagram of a prior art.

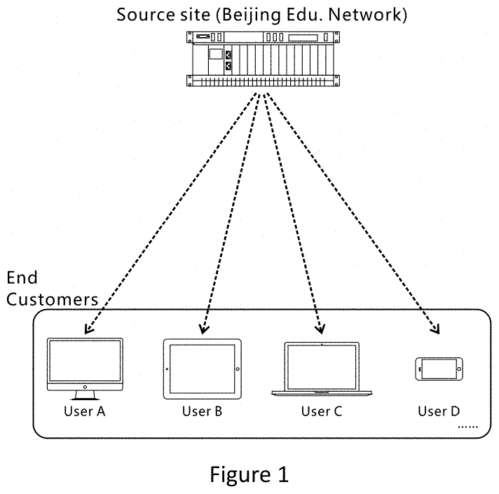

FIG. 2 is a schematic structural diagram of another prior art.

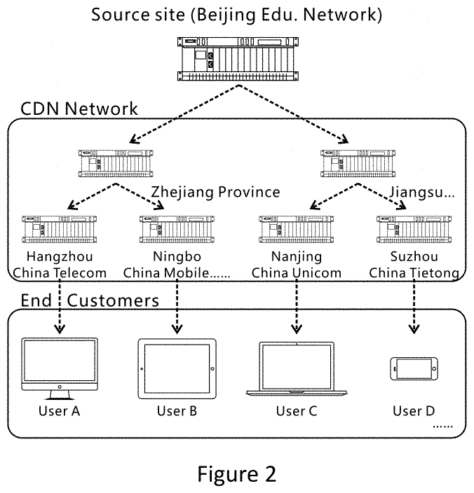

FIG. 3 is a schematic structural diagram of a peer-to-peer content distribution network system based on distributed election of the present invention.

FIG. 4 shows the specific composition and structure of FIG. 3.

### DETAILED DESCRIPTION OF PRESENT INVENTION

Embodiments of the present invention are further described below with reference to the accompanying drawings.

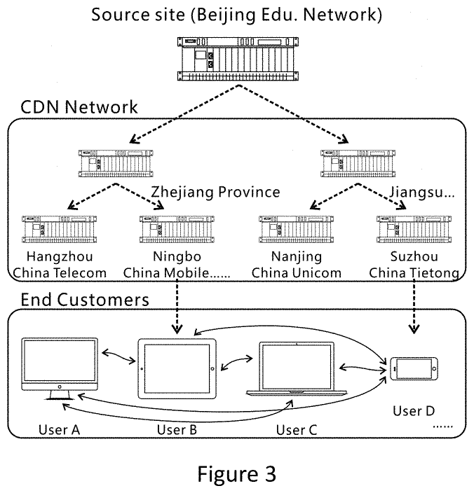

Referring to FIG. 3, it is assumed that user A, user B, user C, and user D are watching videos in the same page at the same time. Then they can avoid the vast majority (up to more than 98%) of traditional CDN network traffic by sharing with each other the resource cache (data chunk) that they have downloaded from the traditional CDN network or other users.

This form of end-user interconnection and mutual assistance, on the one hand, greatly reduces the pressure on the traditional CDN network and the traffic cost of the CP. On the other hand, the more users are online at the same time, the more people participate in mutual sharing, so that the access speed of resources will be faster and less stuck. As a result, the more online users, the better the user experience.

For example: Tom opened the “metube” website at his home in Yangpu District, Shanghai, and watching the “Captain China” video. It happened that there was a Jerry in Hongkou District of Shanghai who was also watching this video. Now that Tom has downloaded the video content that Jerry is going to watch, Jerry doesn't need to download it again from the “metube” site, but directly from Tom (with Tom sharing the data directly to Jerry). Others such as John, Mary, Mike, etc. are similar. Most users no longer need to download resources from “metube” or its CDN channels, but can share them with each other in real time.

In this way, metube firstly can save as much as 98% or even higher traffic costs: most of the network traffic that would have been downloaded from the metube origin site and its CDN channel was eliminated by the mutual sharing between users. Secondly, it also solves the problem that playback freezes when there are many people watching at the same time: The more people watching, the more people sharing with each other, and the smoother the playback will be.

The above is just an example, in fact, the present invention has a wide range of applications and can be used for (including but not limited to):
Audio and video live and on-demand platforms: For users, the video opens faster, eliminates stuttering, and has a higher bit rate. For the platform, it can greatly reduce the traffic cost.
Video and audio online meeting or communication platform: For users, the meeting is smoother, the delay is lower, and the audio and video quality is better (higher bit rate can be used). For the platform, it can significantly reduce the traffic overhead and greatly reduce the forwarding cost of real-time streaming media.
Image, document, file sharing platform: Significantly speed up the download speed of images, documents and other formats of files, significantly improve the loading speed of popular pages, and greatly reduce traffic costs.
Paid training platform: Through strong encryption and a public key architecture (PKI)-based key distribution mechanism, media and files that are paid for distribution cannot be intercepted and stolen by malicious third parties. At the same time, it speeds up resource loading and reduces traffic costs.
Mobile games, PC games, web games, etc.: Accelerate the download of resource packs and reduce traffic costs.

And any cases that needs to distribute content (data).

In addition, benefit from standard components like WebRTC Data Channel, this solution can not only be built into various apps, but also can be directly used in browser pages (Web pages). That is, any browser page can become a client of p2pcdn, share the resources (data chunks) it has obtained with other clients (other web pages or apps), or obtain the resources (data chunks) it needs from other clients (web pages or apps).

In summary, this technical solution at least has following advantages:
Low traffic cost: It can reduce the traffic cost of CP by more than 98%.
Good user experience: avoid freezing, the more users online at the same time, the faster the speed and the smoother the playback.
Strong adaptability: Different from “BT Download”, “E-Donkey Download”, “Baidu Gold Mine”, “Xunlei Money-making Treasure/Xunlei Wanke Cloud”, “Youku Routing Treasure”, etc. which require users to install corresponding applications and/or use Dedicated hardware solutions.
Good adaptability: It can better adapt to the unpredictable node and data availability changes of the p2p network. In the p2pcdn network, users may perform various operations at any time, such as: closing or refreshing the current page, jumping to other pages, switching video resolution, switching audio tracks (dubbing), and jumping playback progress. These random and intensive operations will make the data chunks that a user can share at one moment cannot continue to be provided at the next moment. The present invention can well solve the real-time resource sharing problem in the situation of “the network nodes and resources are changing dynamically at any time”.
Strong real-time: The refined scheduling at the data chunk level can better support scenarios with high real-time requirements such as live audio and video, web conferences, and web video chats.
   High degree of sharing: Refined scheduling at the data chunk level can also significantly improve the efficiency of resource sharing—Users can immediately share downloaded chunks of data in their cache with others, rather than waiting for a specific resource to be fully downloaded before sharing it.
Wide compatibility: Wide range of applications, suitable for various resource request related occasions such as audio and video on demand, live broadcast, picture, file and other resource download. Compatible with major browsers and operating system platforms at the same time.
Simple and easy to use: It only needs to reference a js file in the existing page and make a few modifications to enable the p2p CDN function.
Fairness and mutual benefit: Due to the inability to solve core problems such as “real-time accurate tracking, scheduling, routing and coordination for unpredictable and massive shared resources and p2p endpoints”, therefore, the existing “P2P CDN” technical solutions such as “Baidu Gold Mine”, “Xunlei Money-making Treasure/Xunlei Wanke Cloud”, “Youku Routing Treasure”, etc. all require users who want to share their own bandwidth to purchase hardware boxes dedicated to the above manufacturers. In other words, the user must first buy a small CDN server (of course, in most cases, this small CDN server is also packaged to function as a broadband router at the same time).
   While bypassing the core technical challenges it cannot solve, its model also goes astray:
   Users are required to purchase, deploy and implement dedicated hardware: It takes money to buy hardware, and considering the technical background of most netizens, even if they buy it back, they still lack the technical background for correct implementation and deployment.
   Does not follow the principle of equality and mutual benefit, for example, Tom bought the CDN router of “youku” network, then:
1. So whether Tom is watching youku or not, he has to contribute his power and bandwidth 7×24 hours to help youku share content with others.
2. Even if Tom is watching youku, what he is sharing is not the video he is watching. Instead, youku first uses Tom's home bandwidth to download the content that the website thinks needs to be shared to the box, and then uses his uplink bandwidth to share these content that Tom himself doesn't know what it is.
3. This box is owned by youku from hardware, system to application, and they can remotely control this box to do anything in Tom's house.
   Therefore, compared with the present invention, the above-mentioned technical solutions have at least the following disadvantages:
1. Require users to purchase dedicated hardware;
2. Requires the user to be able to implement and deploy the hardware;
3. User concerns: 7×24 sharing—grab my bandwidth and slow down the Internet speed;
4. There is a cost: Since the principle of equality and mutual benefit is not followed, the bulk of the profit is to be distributed to users—it must operate according to the mode in which users provide their traffic for a fee;
5. Limited resources: only fixed users who purchase hardware and join the plan can provide bandwidth, and cannot fully utilize the idle upload capacity of all online users;
6. Poor scalability: Since the p2p nodes are fixed, the traffic output capacity cannot be increased proportionally with the increase in the number of online users.
   Obviously, the cost of such a model is still high, and it is difficult to obtain the real recognition and support of the majority of users.
   The present invention solves the challenges in the above-mentioned traditional p2p CDN technology well, so it can follow the fairness criterion of equality and mutual benefit, and avoid the above-mentioned problems: Users only need to help others reciprocally when they enjoy being helped by others. Stop helping others as soon as the user stop enjoying their help. And there is no need to purchase and install any special software or hardware, and it only needs to run in a secure sandbox environment such as a browser.
   The present invention does not need to purchase and deploy additional dedicated software and hardware facilities, so that almost all online users can contribute their own traffic, and truly achieve “the more people, the faster”. At the same time, thanks to the strict adherence to the principle of reciprocity and mutual benefit, users' uplink resources can be used for free to help each other, which greatly reduces traffic costs.

### 1. Preliminary Knowledge

From the above scenario, we can easily see that it is different from the traditional p2p sharing mechanism of static resources such as BT and eDonkey. The core difficulty of p2p CDN is that it needs to perform strong and consistent real-time tracking and scheduling of massive online objects (data chunks) with ultra-high performance. As well as dealing with large-scale concurrent connections and requests, and unpredictable dynamic routing planning and other issues.

For example, the user may close the webpage at any time, drag the playback progress bar greatly to jump, or switch the resolution of the video (such as switching from 720p to 1080p) or the audio track (such as switching from Mandarin Chinese to English), these actions will cause the user's previously cached data to be completely discarded at the moment when the above actions are initiated, and thus cannot be shared any more.

For another example, when a user watches an online video normally, only limited data is cached in the player. For example, a video player in a website page may only cache audio and video data 300 seconds before and 120 seconds after (pre-reading) the current playback time point, and data beyond this cache window will be discarded. Therefore, even when the user is watching the video normally, a dynamic process in which the old cache is continuously invalidated (eliminated) and the new cache is continuously loaded (pre-reading) will continue to occur. Not to mention the situation when the user jumps by dragging the player's progress bar (causing a lot of old caches to be invalidated and a lot of new caches to be loaded). Therefore, it is necessary for p2p cdn nodes to perform fine-grained distributed real-time tracking and scheduling in units of data chunks of smaller size (for example, each data chunk is 16 KB, 32 KB, 48 KB, 64 KB, 256 KB, 512 KB, etc.).

It can be seen that in the above-mentioned ultra-large-scale concurrent environment where the node state is unstable (rapid changes), Fine-grained real-time tracking and scheduling requirements for massive data chunks can only be well supported by using distributed server clusters and high-performance, large-capacity distributed coordination algorithms.

Well-known distributed coordination (service election) algorithms are broadly divided into the following two categories:

The first is the majority voting algorithm, such as the Paxos algorithm, represented by Apache ZooKeeper (https://zookeeperapache.org/, https://en.wikipedia.org/wiki/Apache_ZooKeeper) and Google Chubby (https://static.googleusercontent.com/media/research.google.com/zh-CN//archive/chubby-osdi06.pdf), etc.; Raft algorithm, the representative product is Consul (https://www.consul.io/, https://en.wikipedia.org/wiki/Consul_(software)), and etcd (https://etcd.io/, https://en.wikipedia.org/wiki/Container_Linux#ETCD), etc.; and Byzantine Algorithms, and so on.

All of the above majority voting algorithms can provide strongly consistent and highly available distributed coordination (such as service election, service discovery, distributed locks, etc.) services. However, there are also disadvantages such as small capacity (usually the online objects that can be managed at the same time are at the level of 100,000), poor performance, and high overhead (multiple network broadcasts and multiple disk IOs are generated for each request). Due to its high requirements on network throughput and communication delay, it cannot be deployed in a cross-IDC (metropolitan area network or wide area network) environment. It is also unable to cope with scenarios such as high-performance real-time coordination of massive objects in a high-concurrency environment.

The second is the hashing/consistent hashing algorithm: this algorithm achieves the purpose of electing the master/owner (service election) by computing operations such as hashing the unique characteristic values such as the name or ID of the managed (elected) object.

Take the most common modulo algorithm as an example: Suppose the current server cluster contains N nodes, and the node numbers are 0, 1, 2, . . . , N-1 in sequence. At this time if:
a) All nodes know that there are N nodes in the current cluster that are normally online, and
b) Every node agrees to divide the characteristic value such as the ID of any given object or the hash of the object name by the number of nodes in the current cluster (N), and then take the remainder (modulo) to be the owner node's number of the object.

Then in theory, for any given object, a unique owner node corresponding to it in the current cluster can be elected. E.g:

Suppose the current server cluster contains 100 nodes, and the node numbers are 0, 1, 2, . . . , 99. At this time, given an object with an ID of 12345, the object belongs to the node numbered 45 in the cluster (the remainder of 12345 divided by 100 is 45). That is: the owner of the object is the 45th node.

Well-known products that use such algorithms are memcached (https://memcached.org/, https://en.wikipedia.org/wiki/Memcached) and redis (https://github.com/antirez/redis, https://en.wikipedia.org/wiki/Redis) etc.

As we all know, this method has at least the following defects:
1. Consistency problem: The assumption that this scheme can be established is that each node in the cluster knows exactly how many nodes are included in the cluster at every moment. This is actually unrealistic, because the nodes in a cluster will increase or decrease at any time due to failure, operation and maintenance, etc.
Consider the cluster in the example above, where the number of nodes decreased by 2 at some point (from 100 to 98) due to power, network, or hardware failures. Then it is basically impossible for the remaining 98 nodes to perceive the occurrence of this event at the same time. That is: even if the all remaining 98 nodes will eventually sense that 2 nodes are offline, but this sensing process is not uniformly completed on the 98 nodes at the same time. Instead, there is an order between each node.
2. For example, when 2 nodes in the cluster go offline for 500 ms, it is very likely that node 0 has not yet sensed that they are offline, and thinks that all 100 servers in the cluster are online; And node 1 has detected that a node is offline at this time, so it believes that there are still 99 nodes online in the current cluster at this time; And node 2 detects that all 2 nodes are offline at this moment, so it believes that only 98 nodes are online in the current cluster at this time.
Then if the object with ID 12345 is given at this time, node 0 will consider its owner as node 12345% 100=node 45; node 1 will consider its owner as node 12345% 99=node 69; and node 2 will determine that its owner is 12345% 98=node 95.
As can be seen from the above example, whenever the number of online nodes in the cluster changes, using this algorithm to select the master may cause serious consistency problems: When different nodes in the cluster process the requests for the same object (such as the same resource or data chunk), they will choose different owner node for the object. This leads to inconsistencies such as multiple masters and split brains.
It should be noted that “consistent hashing” does not solve this problem, and the “consistent” in its name is only to alleviate the problem of owner failure mentioned below.
3. Owner failure problem: As shown in the previous example in “The Consistency Problem”, a small change in the number of online nodes in the cluster using this algorithm will cause the owner node of a large number (almost all) of the objects to change. That is, in a cluster with N nodes, even if only one node goes offline or comes back online, almost all objects will fail and the owner must be re-elected.
Obviously, this kind of thundering herd effect has huge damage to the performance and availability of the cluster. Consistent hashing algorithm can control the failed objects to M/N of the current total number of objects when M nodes change in the N-node cluster. For example, in a 100-node cluster that manages 10 million objects, if 2 nodes suddenly go offline, 10 million×(2/100)=about 200,000 objects will fail. Therefore, although the consistent hash algorithm does not eradicate the above-mentioned owner failure (thundering herd) problem, it does effectively alleviate it.
4. Load imbalance: This method uses a fixed mathematical formula for owner election, and does not consider the load of each server node in the current cluster at all. It is also impossible to dynamically redistribute (rebalance) the load according to the current load of the cluster in real time. Therefore, it may happen that some nodes in the cluster are heavy-loaded (or even overloaded), while other nodes are lightly loaded (or even no load). This not only reduces the overall utilization and cluster performance of the cluster, but also degrades the user experience.

It can be seen that the existing distributed election algorithms each have problems in terms of capacity, performance, overhead, and consistency that cannot be ignored.

To solve the above problems, we invented the BYPSS distributed coordination algorithm: BYPSS can provide the same (or even higher) level of strongly consistent, highly available distributed coordination algorithms as Paxos/Raft, while eliminating all of its network broadcast and disk IO overhead. At the same time, BYPSS also provides users with ultra-high capacity to coordinate and manage trillions of online objects at the same time; and super processing performance of tens of millions of concurrent, hundreds of millions of requests per second. Compared with the above-mentioned traditional algorithms and products such as Paxos/Raft, its capacity, performance and overhead are improved by thousands to hundreds of thousands of times.

For a detailed description of BYPSS, please refer to the patent: CN2016103238805, PCT/CN2016/093880 (WO/2016/169529), U.S. Pat. No. 10,523,586B2 (US20180048587A1), EP16782676 (EP3422668), SG11201808659V, KIRK-19002-HKSPT (19119473.7), J/003824(460) and so on.

Because the present invention needs to carry out owner node election for massive data chunks. The elected owner node is responsible for tracking the status (Such as: the encryption key, checksum, digital signature, authorization information and the health status of data chunk; the current list of peers that can provide this data chunk, and the ISP, geographic location, SID and other information corresponding to each peer) of the corresponding data chunk in real time.

At the same time, considering the huge advantages of the BYPSS algorithm in its performance, overhead, capacity, consistency, availability, etc., we will take BYPSS as an example below to describe the technical solution of the present invention (That is: BYPSS can provide the present invention with the advantages of strong consistency, high performance, large capacity, high concurrency, etc.). However, it should be noted that: BYPSS is only an example used for convenience of description, and replacing it with any other election (owner election) algorithm above or not above will not have any impact on the present invention.

### 2. Basic Concepts

In the p2pcdn service, each User can have any number of sessions at the same time (For example, a user can log in to the same application with the same account on multiple devices at the same time, or a user can open multiple browser pages on the same site at the same time. For example, the user Tom opens the “Chinese Captain” video page on the site “metube” in the IE browser; at the same time, he opens the “Chinese train captain” video page on the site “metube” in the Chrome browser, Tom now has two active “metube” sessions at the same time). In each Session (for example, if a user opens a video playback page, the page can be considered as an independent session. A session is usually identified by an ID, the ID of a session is called a Session ID or SID), any number of Resources can be included at the same time. And each resource can contain any number of Data Chunks at the same time.

The “resource” can be any data or real-time data stream such as pictures, files, audio, video, programs, documents, messages, etc. A resource can be composed of any number of data chunks. The data chunk usually has a predetermined fixed size (However, it can also be any size that is different from each other. For example, when processing segmented data such as HLS and DASH, or processing CMAF HLS, CMAF DASH and other segmented and then fragmented data, even if each data chunk in the same resource may also have different sizes). The data chunks in a resource are usually numbered sequentially in ascending order (although data chunks can be identified in any way, such as numbers or names). Therefore, each data chunk represents a certain piece of data in the specified resource.

For example, under the premise that the size of the data chunk is 32 KB, the data chunk No. 0 in the resource: “2020/Captain China.1080p.mp4” represents the data of the 0th˜32767th bytes in the resource, and its No. 1 data chunk represents the 32768th˜65535th bytes of data, etc., and so on.

In addition, in the present invention, the resource name is used to uniquely identify a resource. Obviously, the resource name should have the following two characteristics:

The same resource should have the same resource name: Unless you want to pre-distribute the super hotspot (Example: Live video with hundreds of millions or more expected simultaneous viewers) resources without relying on the automatic data chunk splitting/merging algorithm of the present invention, you should try to ensure that the same resources have completely consistent resource names.
For this reason, in situations such as multi-protocol (supports both http, https, rtmp) or multi-host aliases (cdn.mysite.com, www.mysite.com, mysite.com), choosing to use raw URLs directly as resource names may not be a good idea. Because various combinations of different protocols and different hostnames may all point to the same resource, this allows a resource to have multiple names at the same time (thus creating a split in the p2pcdn system).
Different resources should have different resource names: Undoubtedly, a resource name should uniquely identify at most one resource without ambiguity at any given time. Ambiguity can lead to the sharing of wrong chunks of data between p2p endpoints.

In one embodiment, a data chunk may be uniquely identified by the combination of the resource name to which it belongs and the serial number of the data chunk (also referred to as a data chunk ID, or just Chunk ID). For example: “2020/Captain China.1080p.mp4:0” can represent the No. zero (first) data chunk under the resource “2020/Captain China.1080p.mp4”. According to the previous example, this represents 32 KB of data in the resource file “2020/Captain China.1080p.mp4” in the range of bytes 0 to 32767.

It should be noted that the above-mentioned session ID, resource name, and data chunk encoding are only used as examples. In practical applications, they can be strings (any character set encoding), integers, fixed-point numbers, floating-point numbers, binary data chunks (BLOBs) etc., and data (byte sequences) in any format. The present invention does not have any limitation on this.

### 3. System Composition

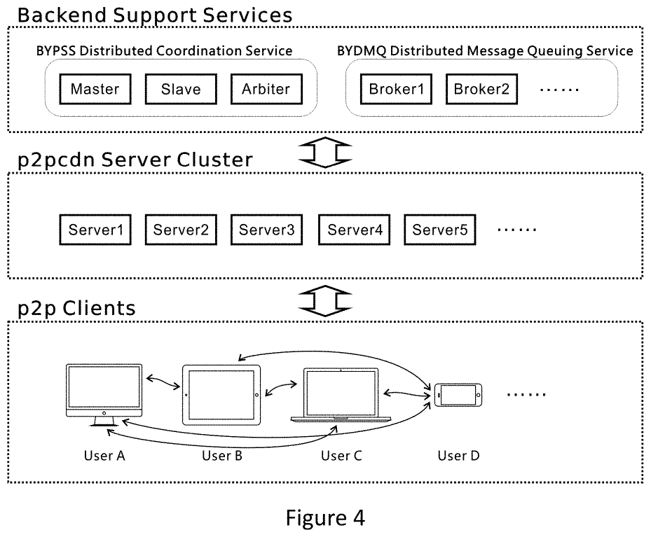

As shown in FIG. 4, a typical p2pcdn system consists of three parts: back-end support services, p2pcdn server cluster and p2p client.

### 3.1. Back-End Support Services

The back-end support services mainly include distributed coordination service and distributed message queue service.

In the p2pcdn system, distributed coordination algorithms and/or services such as BYPSS are mainly used to complete services such as service election and service discovery:
1. Service election: As mentioned above, the p2pcdn server cluster implements the distributed service election function for the server cluster through distributed coordination services or algorithms.
Preferably, BYPSS can provide distributed coordination algorithms and/or services with strong consistency, high availability, high performance, high concurrency, low overhead, and large capacity for the p2pcdn server cluster.
The objects of service election are mainly resources, data chunks, users and sessions. For example, a p2pcdn server cluster can use the distributed coordination service to elect a unique p2pcdn server node as its owner for each online data chunk (“online data chunks” are active data chunks that have recently been shared and/or used) in the system respectively.
Similarly, the p2pcdn server cluster can also elect the corresponding owner server node for resources, sessions, users and other online objects through this service.
2. Service discovery: The nodes in the p2pcdn server cluster can query the current owner node information of the specified object through distributed coordination algorithms such as BYPSS. For example, a server node can query the owner node ID and network address of a certain data chunk through the BYPSS service.

Preferably, service discovery and service election can be optimally combined into one request. For example, server node 1 initiates an election to BYPSS and elects itself as the owner of data chunk A. If the election is successful, server node 1 officially becomes the sole owner of data chunk A within the cluster (of course, the owner qualification can be actively discarded or passively deprived due to management, scheduling and failure reasons). Otherwise (other node has become the current owner of data chunk A), BYPSS returns the current owner information of data chunk A, such as the owner ID and its address.

In this way, the two actions of service election (if successful) and service discovery (if failed) can be completed at the same time with only one request, which significantly improves the request efficiency.

It should be emphasized again that the BYPSS is used as an example to illustrate the distributed coordination service only for convenience. In practical scenarios, various algorithms and/or products and services, including but not limited to the foregoing, may be used to implement the above functions.

Furthermore, the distributed coordination service is only a logical service. It can be deployed as an independent service on the same or different physical or logical nodes as other roles (for example: p2pcdn server cluster) in the p2pcdn system, or it can also be embedded and/or integrated into other business logic as part of other roles in systems such as p2pcdn servers (for example: it can be built into the business logic of a p2pcdn server node or p2p client node).

That is to say, no matter how the above algorithms such as service election and service discovery are finally realized, and how they are implemented and deployed, the effectiveness of the present invention will not be affected in any way.

The distributed message queue service provides high-performance communication algorithms and/or services between server nodes for a cluster of p2pcdn servers. The distributed message queue service can be either message middleware with specialized message forwarding nodes (Broker) such as BYDMQ (http://baiy.cn/doc/byasp/mSOA.htm#BYDMQ, http://baiy.cn/doc/byasp/mSOA_en.htm#BYDMQ), RabbitMQ (https://www.rabbitmq.com/, https://www.rabbitmq.com/), RocketMQ (https://rocketmq.apache.org/, https://en.wikipedia.org/wiki/Apache_RocketMQ), Kafka (https://kafka.apache.org/, https://en.wikipedia.org/wiki/Apache_Kafka) and Redis (https://github.com/antirez/redis, https://en.wikipedia.org/wiki/Redis), etc.; it can also be a direct communication algorithm built into the business logic of a specific application (for example: a p2pcdn server node) such as ZeroMQ (https://zeromq.org/, https://en.wikipedia.org/wiki/ZeroMQ).

That is: similar to the distributed coordination service, in the present invention, the message queue service is only a conceptual logical component. It only represents that the various nodes in the p2pcdn server cluster can communicate with each other (deliver messages). It can be deployed as an independent service on the same or different physical or logical nodes as other roles in the p2pcdn system (for example: p2pcdn server cluster), It can also be embedded and/or integrated into its business logic as part of other roles within a system such as a p2pcdn server (e.g.: build it within the business logic of the p2pcdn server node).

That is to say, no matter how the above-mentioned message queuing service is finally realized, and how it is implemented and deployed, it will not have any impact on the effectiveness of the present invention.

### 3.2. p2pcdn Server Cluster

The p2pcdn server cluster upwardly consumes services such as service election and message communication provided by the back-end support services, downwardly receives and processes various requests initiated by the p2p client, and provides the client with services such as p2pcdn tracking, scheduling and coordination. A p2pcdn server cluster can contain any number of server nodes.

The p2pcdn server cluster itself manages users on a session-by-session basis, and manages all currently active (being shared and used) online resources on a chunk-by-chunk basis.

In the current server cluster, the p2pcdn system elects a uniquely determined owner server node at the current moment for each online data chunk respectively. Preferably, BYPSS can ensure that in a p2pcdn server cluster, any specified data chunk has at most one owner node at any given time (that is, it can provide strong consistency guarantees, and problems such as multi-owner and split-brain will not occur).

At the same time, if the p2pcdn server itself is implemented in the form of multi-threading, multi-coroutine or multi-process, the corresponding owner thread (or owner coroutine, owner process, etc.) can also be elected for each data chunk (note: the node has successfully obtained the ownership of these data chunks through elections) within the server node respectively. Preferably, since the consistency within the same node is easy to guarantee, and there is no problem such as failure, the secondary election within the node can be implemented by simple algorithms such as hashing and modulo.

After a p2pcdn server node elects a given data chunk through a distributed coordination algorithm and/or service, and successfully obtains its ownership (ie: becomes the owner node of the data chunk), this server node can track, coordinate, analyze, match and do other management work on the data chunk until it loses (deregisters or invalidates) its ownership. Specifically, it can include:

A server node can maintain a donor endpoint table for each data chunk belonging to it respectively: [symbol] DONOR ENDPOINT TABLE [symbol] contains all p2p client endpoints that can provide this data chunk (i.e.: can share this data chunk with other users or sessions, hence the name “DONOR” endpoint). It can also include the ISPs (Internet Service Providers, such as China Telecom, China Mobile, China Unicom, AT&T, etc.) to which these donor endpoints belong, their regions (such as Shanghai, China, Zhejiang, Los Angeles, etc.), and Any additional status and descriptive information including its contribution degree (calculated based on factors such as the number of successful sharing times, successful sharing traffic, and success ratio), sharing frequency, etc. This information can be used to more accurately describe the specific details (portraits) of each donor p2p client endpoint (Donor Peer) for more accurate p2p subnet matching.
The above-mentioned donor endpoint table can be implemented by (including but not limited to) hash table, red-black tree, B+ tree, array, linked list and other arbitrary data structures and algorithms. And any number of single or compound fast query index structures based on ISP, region, contribution and other characteristics can be established for it.
A p2p client can directly or indirectly (for example: forwarded by other clients, servers or message middleware) initiate a request to the owner server of the specified data chunk, declaring that it can or cannot continue to share the data chunk. After receiving this request, the owner server can record these changes by modifying the corresponding entries in the donor endpoint table corresponding to the specified data chunk of the client node.
For example: After server 1 (Server No. 1 in the p2pcdn server cluster) receives the request (statement) that “the data chunk C can be shared with other client endpoints” sent by p2p client A (the donor endpoint), the SID (session ID), ISP, region and other information of client A can be added to the donor endpoint table of data chunk C (Assume that server 1 is currently the owner of data chunk C). If after a few minutes, server 1 receives a request to “stop supplying data chunk C” from endpoint A. Then, the entry corresponding to endpoint A can be deleted in the donor endpoint table of data chunk C, or the record can be marked as unavailable.
The server node can maintain any additional status and description information for each data chunk belonging to it respectively, including the resource ID to which it belongs, the last access timestamp, and its most recent valid operation. This information can be used to help the p2pcdn system more accurately understand the current status of each data chunk under it, In order to facilitate more effective management operations such as prioritization, deregistering (retire/eliminate, give up ownership of the data chunk and release all related resources such as the corresponding memory), and so on.
For example, data chunks that have not been accessed within a specified period of time can be actively eliminated periodically by using the most recent timestamp. Or by using the LRU list and other methods to reverse the order of activity, forcibly retire those chunks that exceed the current node's maximum capacity limit, starting with the least active chunks, and so on.
A server node can perform p2p client [symbol] SUBNET MATCHING [symbol] for the data chunks belonging to it: when a p2p client endpoint directly or indirectly requests the owner node of a given data chunk to establish a connection between this p2p client endpoint and the donor endpoints of the data chunk (We call the p2p client endpoint that initiates this request and is ready to receive chunks from the donor endpoint the “DONEE” endpoint). The owner server node can make any number of donor matches this donee for this request.
The matching can be performed by utilizing the donor endpoint table corresponding to the specified data chunk, the matching rules can be any matching method such as (including but not limited to): sequential matching, random matching, ISP priority matching, geographic location priority matching, ISP+geographic location priority matching, ISP+contribution+geographic location priority matching, or Any combination of these matching rules. Any number of donor nodes can be included in the results of each match.
After the matching is completed, the server node can directly or indirectly contact the donee (requester) and the matched donor to help them successfully establish a connected p2p direct network (p2p subnet). After a p2p direct connection subnet is successfully established between the donee and the matching donor, the donor can directly send the data chunks required by the donee to the donee through the p2p subnet (that is: the transmission of the data chunk occurs directly between the donee and the donor endpoint, and does not need to be relayed through nodes such as p2pcdn servers).
For example: p2p client A (the donee endpoint) initiates a request to server 1 to find suitable donor endpoints for the specified data chunk D belonging to the server. Server 1 uses the donor endpoint table corresponding to data chunk D stored in its memory, perform optimal matching according to the dimensions of both parties' ISP, geographic location, contribution, sharing frequency, etc., and finally 16 optimal donors (p2p client endpoints B1˜B16) matching endpoint A were selected.
After the matching is completed, server 1 respectively contacts endpoint A (the donee) and endpoints B1˜B16 (the 16 donors) respectively, and coordinate, guide and assist them to establish smoothly connections by exchanging their respective SID, request data chunk (resource name+data chunk number), SDP Offer and SDP Answer message, NAT traversal message (ICE Conditions) and other information.
Assuming that the endpoint B16 fails to connect with endpoint A due to network connectivity or other issues, so after completing the above steps, endpoint A has successfully established direct connections with 15 donors such as endpoint B1 to endpoint B15, respectively (that is: 15 p2p direct connections, which are connections A-B1, A-B2, A-B3, . . . , A-B15). This directly connected network can be regarded as a small p2p network with node A as the center and 15 edges radiating from A (each edge is connected to a corresponding endpoint in B1˜B15). Since this p2p network is usually a tiny subset relative to all p2p clients managed by the current p2pcdn system and all possible combinations of p2p connections between them, we call this p2p network “ [symbol] P2P SUBNET [symbol] ”.
In other words, a “p2p subnet” is a preferred connection method for a specific supply and demand relationship which is selected from all current p2p client endpoints and all possible 1:N connection sets (that is: in a set containing M client endpoints, traverse each endpoint one by one, and make the endpoint selected each time and all the remaining N (1≤N≤M-1) endpoints in the set, in all Perform various possible 1:N connection combinations within the legal range of N subnet sizes, and then summarize the set of all 1:N possibilities formed by the above permutations and combinations).
Preferably, due to the characteristics that data chunks belonging to a resource will always be consumed in sequence in most cases, so a p2p subnet is in most cases not just used to share only one chunk of data. For example, endpoint A can try to request more data chunks required by it and located near with data chunk D from B1˜B15 and other donors through the above-mentioned p2p subnet, such as data chunk D+1, data chunk D+2, data chunk D+3 and so on. We discuss this optimization method, known as “freewheeling,” in detail below.
Data chunk level split/merge: When there are too many sessions sharing and requesting a certain data chunk at the same time, in order to balance the server load and provide sharing efficiency, the hot data chunk can be split, that is, a data chunk is split into more clone chunks, each of which is managed by a different owner server.
Preferably, the sessions (donee and donors) related to the hotspot data chunk can also be allocated (with arbitrary rules) to the clone chunks for separate management.
For example: when the number of related sessions (donees and donors) of a data chunk A exceeds the threshold set by the system of 100,000,000 (one hundred million), The system can split it into 10 clone chunks and hand them over to be managed by 10 different server nodes in the p2pcdn server cluster. Preferably, the sessions associated therewith can also be split accordingly, for example, each node can manage about 10% (about 10 million) of its sessions. Session splitting can be random allocation, sequential allocation, or splitting according to any rules such as ISP, region, and contribution.
Data chunk merging is the inverse of the above behavior: when the number of related sessions of a split data chunk decreases sharply, these clone chunks can be merged back into a data chunk for unified management. Re-merging together the already small number of all related sessions allows for a better overall calculation of the optimal p2p subnet for each subnet matching request.
In addition, it should be noted that the aforementioned “donor” and “donee” are not mutually exclusive roles. Instead, unless (including but not limited to) the following exceptions occured:
   A p2p client cannot establish a direct connection with any other p2p client due to network connectivity (such as firewall, proxy, etc.) or the user manually turning off the p2p acceleration option: at this point the endpoint will become a normal client that only accesses traditional CDN services.
   Because a suitable donor is not matched, a p2p client has obtained all relevant data chunks required by the current session from content distribution channels such as traditional CDN: at this point the endpoint will become a pure donor.
   Because a p2p client is using a metered mobile network such as 3G, 4G, 5G, etc. Suspend its donor function to avoid users paying extra traffic charges: at this point the endpoint will temporarily become a pure donee.
And other special circumstances, otherwise, in a typical p2pcdn system, the vast majority of p2p client nodes play both the roles of donor and donee at the same time. In other words, in the present invention, all p2p client nodes are always equal in identity status. The present invention: neither elect a “Super Peer” client that “issues commands” to other p2p clients (organizes and coordinates other clients) from among them; nor does it restrict that only certain “Publisher Peer” clients with special identities are eligible to share data with other clients; and there is no such concept as “Seed Peer”.
This is essentially different from those technical solutions that elect some special status “super nodes”, “publishing nodes” or “seed nodes” among all p2p client nodes: The present invention only elects the corresponding owner server for the data chunk, and in the present invention, the identities of all p2p client nodes are equal to each other, and there is no special existences such as “leader”, “coordinator”, “publisher”, etc.
In addition, unlike the traditional CDN method, which uses files (resources, whose size is usually several MB to several GB) as a unit, the present invention divides resources into smaller (usually KB-level) data chunks, and it realizes real-time tracking, coordination, analysis, scheduling and matching of each data chunk in the scenario of massive resources and ultra-high concurrent users.
The refined scheduling at the data chunk level can not only better support scenarios with high real-time requirements such as live audio and video, web conferences, and web video chats, but also significantly improve the efficiency of resource sharing—Users can immediately share downloaded data chunks in their cache with others, instead of waiting for a specific resource to be completely downloaded before starting to share it. In addition, the refined resource scheduling at the data chunk level can also better adapt to the problems such as the unpredictable node availability and the ever-changing data availability of the p2p network as described above.
In addition to managing data chunks, the p2pcdn server cluster is also responsible for managing user sessions. Similar to managing data chunks, p2pcdn can also choose an owner server for each session through any distributed coordination algorithm and/or service such as BYPSS. Then the successfully elected owner server is responsible for the management of the session. Specifically, it can include:
   Maintain session table: each p2pcdn server node maintains a [symbol] SESSION TABLE [symbol] , it contains all currently online sessions managed by the node, and for each session, the corresponding SID, last active time, push message queue, ISP, location, contribution, sharing frequency, and information such as the list of resources and data chunks currently being shared by the session.
   Where SID is the unique identifier of the session. The last activity time records the timestamp of the last access to the server by the current session, which is usually used as an important basis for session activity verification (e.g.: Sessions that have not successfully contacted the server for more than a set period of time can be determined to be offline). For an offline session, the p2pcdn system can clear all its status information such as data chunks being shared. [symbol]
   MESSAGE PUSH QUEUE [symbol] is responsible for caching the list of messages to be pushed to the corresponding session. Firstly, the message push queue can temporarily store the messages to be pushed, prevents incoming messages from being lost when the message push connection between the p2p client and the server node is temporarily disconnected. Secondly, it can also provide the function of automatic batch package sending (push) for continuously arriving messages, which can significantly increase the network transmission utilization and throughput. [symbol]
   RESOURCE AND DATA CHUNK LIST [symbol] records all the resources and data chunks currently being shared by the corresponding session. The resource and data chunk list can be used to track and count the current shareable resource status of each session accurately in real time.
   The session table is used to track and maintain the real-time status of all active (online) sessions under the current server node. Based on this, the p2pcdn system can better route, coordinate and schedule resources, data chunks and users (sessions).
   Receive and process API requests from its subordinate sessions: The p2pcdn server node needs to receive and process the API requests of its subordinate sessions. For example: initialization, receiving messages (message push), subnet matching (requesting data chunks), sharing data chunks, revoking data chunk sharing, P2P connection initiation (Offer), P2P connection response (Answer) and other API requests (see below for details).
   Manage [symbol] MESSAGE PUSH CONNECTION POOL [symbol] : Each session (client) can establish a (direct or indirect) message push connection with the server. The message push connection can be implemented in any way, and based on any communication protocol, such as long connection, short connection, long polling, short polling, etc. A client can contain any number of sessions at the same time, and each session can establish any number of message push connections at the same time (But usually in the form of one message push connection per session or per client (user)). The client and the session in it can receive the messages pushed by the server in real time or periodically through the message push connection.
   In the process of connection pool management, the server can forcibly eliminate (disconnect) the timeout, overrun or duplicate message push connections.
   For example: in a specific embodiment, a client can open multiple sessions at the same time, Each session initiates a message push connection to its owner node in the form of HTTP long polling through the “receive message” API respectively. In addition to receiving messages pushed by the server in real time, this connection also serves as a keep-alive function (update its last active timestamp) that provides the server with a heartbeat connection.
   For instance, in this example, we can set the server-side long polling timeout to 60 seconds (each time a long polling request is received and there is no message to be pushed within 60 seconds, an empty response is returned. Each time the client receives a response, it should immediately initiate the next long polling request); client long polling timeout is set to 90 seconds (if no response is received from the server within 90 seconds after a long polling request is initiated, the request will be canceled, and a new long polling request will be attempted immediately.); and set the long polling heartbeat timeout on the server side to 120 seconds (if no long polling request from the client is received within 120 seconds, the session is considered offline).
   The server periodically eliminates connections from the connection pool that have not sent a heartbeat (re-send the request) beyond the set time limit, at the same time, the corresponding session is marked as “disconnected” or “to be verified”. In the case of exceeding the current server's maximum connection pool limit, the server can eliminate the excess connections on the basis of least recently used (LRU). Since in this embodiment, each session can only maintain one message push connection at the same time, therefore, when another new message push connection belonging to the same session arrives repeatedly, the existing old connection will be forcibly eliminated.
In addition, the p2pcdn server cluster also needs to manage resources. Similar to managing data chunks and sessions, p2pcdn can also choose an owner server for each resource through any distributed coordination algorithm and/or service such as BYPSS. Then the successfully elected owner server is responsible for the management of the resource. Similar to the data chunk management described earlier, The management of resources mainly involves operations at resource granularity, such as: real-time status tracking, resource-level split/merge, scheduling, coordination, etc. As well as the status tracking and overall analysis and management of each data chunk under the resource.
For applications that support user registration and login functions, the p2pcdn server cluster should also support user management functions. Each user can have multiple sessions at the same time. Similar to session management, p2pcdn can also select an owner server for each user through any distributed coordination algorithm and/or service such as BYPSS.
Preferably, in a scenario where user management is enabled, it is also possible to no longer elect a owner for each session individually. Instead, it only conducts owner election for users. Then, the owner server of the user to which the session belongs will uniformly manage all sessions belonging to the user (Obviously, some user-related operations can be implemented more efficiently in this way. For example: scenarios such as pushing a message to all sessions belonging to a specified user, etc.). Similar to session management described earlier, user management mainly involves various real-time status tracking, statistics, request processing and coordination at the user level. It can also include the management of the user's subordinate sessions, such as: status tracking and overall analysis and management.
In addition to the above business logic, the p2pcdn server cluster also needs to implement things such as: configuration management, HAC (failure detection, failover, and failback, which can be implemented through distributed coordination components such as BYPSS, or in any other way), Intra-cluster message communication (message communication between server nodes, can be implemented by any method such as distributed coordination services with message dispatching functions such as BYPSS, high-performance distributed messaging middleware such as BYDMQ, or point-to-point direct connection protocols such as ZeroMQ) and other common functions.

### 3.3. p2p Client

The p2p client (p2p endpoint, peer) can exist in any form such as browser pages, or mobile, tablet, and desktop applications. As mentioned above, concepts such as “super node” do not exist in the present invention. All p2p endpoints are fully equivalent in identity: it is both the consumer (donee) of the content and exists as a supplier (donor) of its consumed (successfully downloaded) content. Even if there are occasional exceptions such as those mentioned above due to network connectivity limitations, the above-mentioned peering relationship is not affected in essence.
Since the concept of “a few elite nodes” such as “super nodes” and “publishing nodes” has been eliminated, in the present invention, each p2p node contributes its own strength as much as possible while accepting the help of others, and at the same time shares its own resources (data chunks) with others.
The p2p client mainly completes the following tasks: [symbol]
   INITIALIZATION [symbol] : For newly loaded pages and other situations, the initialization work mainly includes actions such as creating a new session and obtaining the corresponding SID. For a Single Page Application (SPA) or App that is refreshing content, the initialization action is mainly to clear (stop sharing) all old content (data chunks) belonging to the current session, etc. The initialization work can be done through the “Init” API.
   Preferably, while completing the initialization action, the communication between the client and the server can also be bound (in any way) to the owner server node of the new session (session sticky), this can greatly avoid message forwarding in subsequent communications, significantly improving communication efficiency.
   For example: when a user opens a video playback page named “Captain China” in the browser for the first time, the page can obtain a new SID by calling the “Init” API, at the same time, all related requests initiated by the page are bound (sticky) to the owner server node of this new session by methods such as browser cookies.
   At the same time, if the page is a single-page application, that is: there is no need to refresh (reload) the current page or jump to other pages when jumping from the playlist or jumping to the relevant recommended videos within the page. Then, after completing the content switch (example: switch to a new video called “Chinese train conductor”) in this page, the “Init” API should be called again to flush (stop sharing) all old content belonging to the current session (that is: clear all data chunks belonging to “Captain China”). And restart to acquire and share the relevant data chunks of the new resource “Chinese train conductor”.
   Please refer to: “ [symbol] DONOR ENDPOINT TABLE [symbol] ”, “ [symbol] SESSION TABLE [symbol] ”, “ [symbol] Init API [symbol] ” and other relevant subsections. [symbol]
   RECEIVE MESSAGE PUSH [symbol] : After successful initialization, at least one message push connection should be maintained between the p2p client and the p2pcdn server cluster, used to receive push messages from the server. Preferably, the message push connection can also be used as a heartbeat connection, and a heartbeat signal is periodically sent to the server.
   For example, after the browser playback page in the above example is successfully initialized, it can call the “receive message (message push)” API on the p2pcdn server by means of HTTP long polling to establish a message receiving connection. Preferably, the client can make the message receiving connection also serve as the function of the keep-alive heartbeat connection by immediately initiating the next request every time the API returns (whether it is due to receiving a message packaged and pushed by the server or a timeout)—The session can be considered offline if the server does not receive a “receive message (message push)” API request from the client within the specified timeout period.
   Please refer to: “ [symbol] MESSAGE PUSH QUEUE [symbol] ”, “ [symbol] MESSAGE PUSH CONNECTION POOL [symbol] ”, “ [symbol] WaitMsg API [symbol] ” and other relevant sections. [symbol]
   RESOURCE REQUEST [symbol] : The client can obtain the required resources through the “subnet matching (request data chunk)” API, or directly download from traditional CDN, etc.
   As mentioned earlier, when a p2p endpoint acts as a donee, after making a “subnet match (request data chunk)” API call to the p2pcdn server, the server will match any number of p2p endpoints for this client as its donors according to predetermined rules, and help them establish corresponding p2p subnets. In this process, other APIs such as receiving messages and P2P connection initiation and answer may also be required.
   Preferably, as mentioned above, in most application scenarios, all clients request and consume data chunks one by one in increasing order, and eliminate them from the buffer in ascending order. Therefore, in actual usage scenarios, users do not need to call the “subnet matching (request data chunk)” API once for each data chunk.
   On the contrary, since the above-mentioned laws generally hold, so users usually only need to use this API to find a set of peers (donors) that can provide it with the first (usually the smallest sequence number) data chunk it needs, and successfully establish a p2p subnet, there is a high probability that subsequent data chunks can be successfully requested from them. We call the above mode “freewheeling”.
   Usually, this “gliding” will only fail when the user drags the playback progress bar (jumps the video playback progress), switches audio tracks, etc. At this point, this method can be called again to start a new “freewheel” process. In other words, the sharing of resources (data chunks) in p2pcdn consists of a “freewheeling” process one after another.
   Please refer to: “ [symbol] SUBNET MATCHING [symbol] ”, “ [symbol] AcquireChunk API [symbol] ” and other relevant subsections. [symbol]
   RESOURCE SHARING [symbol] : The client can declare the current shareable data chunk related information of the session to its owner node through APIs such as “Share data chunk” and “Revoke data chunk sharing”. After the server node (owner) to which the current session belongs receives the corresponding request, it can notify the owner server node of the relevant resources and data chunks of the change (sharing or unsharing) according to the specific situation, and update the corresponding real-time statistics and status information.
   For example: after the server receives the request, it can update its data chunk, sharing frequency and other information in the session table of the owner node, And update its corresponding state information in the data chunk donor endpoint table located on the corresponding owner node, and so on.
   Please refer to: “ [symbol] DONOR ENDPOINT TABLE [symbol] ”, “ [symbol] SESSION TABLE [symbol] ”, “ [symbol] OfferChunk API [symbol] ”, “ [symbol] RevokeChunk API [symbol] ” and other relevant subsections. [symbol]
   P2P CONNECTION MANAGEMENT [symbol] : The client can request the p2pcdn server to help establish a p2p subnet through APIs such as “P2P connection initiation (Offer)” and “P2P connection response (Answer)”. Preferably, the above-mentioned P2P connection management related APIs can also be optimized into APIs such as (including but not limited to): “Subnet match (request data chunk)”, “share data chunk”, “initialize”, “receive message (message push)”, etc. In order to achieve the purpose of reducing the number of API calls, improving communication efficiency, and simplifying the number of APIs.
   For example, in the browser page of the above example, the page can establish a p2p subnet with the help of the p2pcdn server through the Data Channel in the WebRTC standard component.
   Please refer to: “ [symbol] p2pOffer API [symbol] ”, “ [symbol] p2pAnswer API [symbol] ” and other relevant subsections.
   Buffer management: In addition to the above main functions, the p2p client should also include basic functions related to specific business logic, such as buffer management, authentication and authorization, audio and video playback, picture display, file editing and saving.
   For example: in the video playback browser page of the above example, after the donee endpoint successfully obtains the specified data chunk through the p2p subnet or traditional CDN channel, the data chunk can be stored in the LRU cache maintained in the page, and associate the data chunk to the video player in the page. At the same time, the page immediately or periodically (for example, every second) calls the “share data chunk” API to share the newly added data chunk in the current page cache (including this data chunk) to other p2p clients.
   Correspondingly, when the data chunk in the LRU buffer is eliminated, the page should call the “unshare data chunk” API immediately or periodically (for example, every second) to revoke the sharing of this data chunk and other data chunks in this period.
   Please refer to: “ [symbol] SUBNET MATCHING [symbol] ”, “ [symbol] AcquireChunk API [symbol] ”, “ [symbol] OfferChunk API [symbol] ”, “ [symbol] RevokeChunk API [symbol] ” and other related sections.
To sum up, the p2pcdn system disclosed by the present invention is composed of a three-layer structure consisting of a back-end support service, a p2pcdn server cluster, and a p2p client. As mentioned earlier, the back-end support services may exist only logically.

### 4. API Primitives

Preferably, the p2pcdn server cluster can provide the following API primitives: initialization (Init), receiving messages (message push, WaitMsg), subnet matching (requesting data chunks, AcquireChunk), sharing data chunks (OfferChunk), revoking data chunk sharing (RevokeChunk), P2P connection initiation (p2pOffer), P2P connection response (p2pAnswer). The following is one by one: [symbol]
   Init API [symbol] (Initialization): Initialize the current session. As mentioned earlier, this API can be used to create new sessions or to flush (empty) all resources (chunks) that are being shared by existing sessions.
   If the client calls this API without specifying a session, the server will create a new session for the request.
   If the client is already in a valid session when calling this API (for example, specifying a valid SID), this method clears all resources and data chunks belonging to the session. As mentioned earlier, this is for single-page applications (SPA) or App clients that need to switch scenes. For example: For a SPA that plays a list of videos, when the user jumps from one video in the list to another, the page can ensure that sharing of all chunks related to the previous video stops immediately by re-calling this method.
   If an invalid session is specified when calling this API, the p2pcdn server can return an error, or create a new session for the request.
   If necessary, the p2pcdn system can use this API or add other APIs to achieve user authentication, authorization, login, logout and other general basic operations according to the actual situation. Since these general basic operations are not directly related to the technical solutions described in the present invention, they will not be repeated here.
   Please refer to: “ [symbol] INITIALIZATION [symbol] ” and other relevant paragraphs. [symbol]
   WaitMsg API [symbol] (Receive message—message push): Start to receive messages pushed by the p2pcdn server. As mentioned earlier, the p2p client calls this request to receive push messages from the p2pcdn server. Clients can call this API in various ways and any communication protocol, such as long connection, short connection, real-time or polling. The server will push messages to the client through this API.
   For example, in one embodiment: the server can push the following message to the client through this API: [symbol]
   Resource Request “Res.Req” message [symbol] : After the donee calls the “subnet matching (request data chunk, AcquireChunk)” API to complete the subnet matching, pushed by the server to each matching donor endpoint via this API. The message may contain any relevant fields such as: donee SID, request resource name, request data chunk, and estimated data chunk reading direction and range. [symbol]
   P2P connection establishment negotiation invitation “P2P.Offer” message [symbol] : After the donor endpoint who receiving the “Res.Req” message agrees to share the data chunk by calling the “P2P Connection Initiation (p2p0ffer)” API, the p2pcdn server can push this message to the corresponding donee through this API. The message may contain information such as: the SID of the donor, the name of the resource provided by the donor, the current buffer status of the donor, and any related fields such as the negotiation handshake invitation (for example: SDP Offer, ICE Candidates) message generated by the donor to create a p2p connection. [symbol]
   P2P connection establishment negotiation response “P2P.Answer” message [symbol] : After the donee receives the above “P2P.Offer” message from the donor, If it decides to accept the data chunk shared (provided) by the donor, and calls the “P2P Connection Answer (p2pAnswer)” API for this purpose, then the p2pcdn server will push this message to the corresponding donor. The message can contain any related fields such as: the SID of the donee, the resource name requested by the donee, and the negotiation handshake response (for example: SDP Asnwer, ICE Candidates) message generated by the donee to create a p2p connection.
   Please refer to: “ [symbol] MESSAGE PUSH QUEUE [symbol] ”, “ [symbol] MESSAGE PUSH CONNECTION POOL [symbol] ”, “ [symbol] RECEIVE MESSAGE PUSH [symbol] ” and other relevant paragraphs. [symbol]
   AcquireChunk API [symbol] (subnet matching—request data chunk): The donee calls this method to request p2p subnet matching for data chunk under the specified resource for the purpose of obtaining resources. That is: request to obtain the specified data chunk in the specified resource by means of p2p sharing.
   As mentioned earlier, the purpose of this API is to match the current donee (caller) with donor endpoints that can share (provide) the specified chunk of data. And help them to form corresponding p2p subnets for the purpose of sharing these data chunks.
   Preferably, after completing the subnet matching, the p2pcdn server cluster pushes the resource request “Res.Req” message to each donor endpoint that has been successfully matched this time one by one or in batches.
   Preferably, this API can not only support requests for a single data chunk under a single resource, but also support batch processing modes such as multiple data chunks under a single resource, or multiple data chunks under multiple resources.
   Preferably, the server can return the relevant information of the requested data chunk to the client through this API or other APIs such as WaitMsg. For example (including but not limited to): checksum, digital signature, length, width, start position, playback duration and other related meta information of the data chunk.
   Please refer to: “ [symbol] SUBNET MATCHING [symbol] ”, “ [symbol] P2P SUBNET [symbol] ”, “ [symbol] RESOURCE REQUEST [symbol] ”, “ [symbol] Resource Request “Res.Req” message [symbol] ” and other relevant paragraphs. [symbol]
   OfferChunk API [symbol] (share data chunk): Add new data chunks to the current session so it can be shared with others. As mentioned above, this method can declare to the p2pcdn server in a single or batch form which existing and/or new data chunks in the current endpoint can be shared.
   This method supports calling in real-time or periodic mode. Preferably, it is recommended to call this method periodically (e.g.: once per second) to update the current client-shareable resource (data chunks) incrementally in batches.
   Please refer to: “ [symbol] DONOR ENDPOINT TABLE [symbol] ”, “ [symbol] RESOURCE AND DATA CHUNK LIST [symbol] ”, “ [symbol] RESOURCE SHARING [symbol] ” and other relevant paragraphs. [symbol]
   RevokeChunk API [symbol] (revoke data chunk sharing): Removes the specified shareable (available to other endpoints) data chunks from the current session. As mentioned above, this method can revoke the data chunks in the current endpoint that can no longer be shared (unable to continue to provide) from the p2pcdn server in a single or batch form.
   This method supports calling in real-time or periodic mode. Preferably, it is recommended to call this method periodically (eg, once per second) to batch remove resource increments that are no longer available for sharing in the current client.
   Please refer to: “ [symbol] DONOR ENDPOINT TABLE [symbol] ”, “ [symbol] RESOURCE AND DATA CHUNK LIST [symbol] ”, “ [symbol] RESOURCE SHARING [symbol] ” and other relevant paragraphs. [symbol]
   p2pOffer API [symbol] (P2P connection initiation): Initiate a P2P connection request to the specified session. As mentioned above, if the call is successful, the server will push a “P2P.Offer” message to the specified client.
   Preferably, this method can initiate requests in a single or batch form. In batch mode, this method can initiate different connection requests to different resources for multiple sessions by one call.
   This API can also be simply understood as: push the specified P2P connection establishment request message to the specified p2p client endpoint in the request.
   Please refer to: “ [symbol] P2P connection establishment negotiation invitation “P2P.Offer” message [symbol] ” and other relevant paragraphs. [symbol]
   p2pAnswer API [symbol] (P2P connection answer): Send a P2P connection response to the specified session. As mentioned above, if the call is successful, the server will push a “P2P.Asnwer” message to the specified client.
   Preferably, this method can initiate requests in a single or batch form. In batch mode, this method can initiate different connection answer requests to different resources for multiple sessions by one call.
   This API can also be simply understood as: push the specified P2P connection establishment response message to the specified p2p client endpoint in the request.
   Please refer to: “ [symbol] P2P connection establishment negotiation response “P2P.Answer” message [symbol] ” and other relevant paragraphs.
It should be noted that the present invention does not limit the names of the above APIs, In actual usage scenarios, no matter what its name is, or how the above functions are split and/or combined. As long as it is an API interface that finally implements the above functional primitives, it should be considered to be within the scope of the present invention.

### 5. Typical Workflow

In order to describe its workflow more clearly, as an example, a typical p2pcdn application process of a p2p client endpoint (Peer) is divided into the following steps:
1. Initialization: Use the “Init” API to get or reset the session, and establish a message push connection through the “WaitMsg” API.
2. For each resource on the current page, use APIs such as “AcquireChunk” (through p2p mode) to request data chunk sharing from other p2p client endpoints, and/or obtain these data chunks from traditional distribution channels such as: ordinary CDN, and/or origin site, and/or (including but not limited to) “Baidu Gold Mine”, “Xunlei Make Money Treasure/Xunlei Wanke Cloud”, “Youku Routing Treasure” and other existing “P2P CDN”, etc.
3. Receive the “P2P.Offer” message pushed by the server through the “WaitMsg” API at all times, and call the “p2pAnswer” API to establish a p2p subnet. After the subnet is successfully established, it can directly communicate with each donor endpoint in the subnet via the p2p connections, and receive the contents of data chunks sent (shared) by these donor endpoints.
4. Add the successfully acquired data chunks to the local cache, and publish these shares in real time or periodically (batch) through the “OfferChunk” API. And form p2p subnets through APIs such as “p2pOffer” to share them with other p2p endpoints (Peers).
5. Notify the p2pcdn server of data chunks that can no longer be shared (for example: removed from the cache) through the “RevokeChunk” API in real time or periodically (in batches) to cancel the sharing of these data chunks.
6. Receive the “Res.Req” message pushed by the server through the “WaitMsg” API at all times, and try to establish a p2p connection with the corresponding donee through the “p2pOffer” API. After the p2p connection is successful, the current endpoint can act as a donor and start sharing the requested data chunks with the donee (refer to step 3 above).
7. [Optional] Call the “Init” API again with the current SID before switching resources, leaving the current page or exiting the App, this ensures that all data chunks associated with the current session are flushed (unshared) in time without having to wait for the session to time out.
Also as an example, a typical workflow for a p2pcdn server cluster (server-side logic) is:
1. Wait and accept the next request (usually from the network and initiated by the p2p client):
2. If the request is an “Init” API request, and if the API request is not in a valid session context, it will become or find the owner of the session through election, and create a new entry for the session in the session table of its owner node.
Conversely, if the request is in a valid session context (for example, the request has a valid SID), the session table of the owner node is queried for the entry corresponding to the session. And notify the owner node of each data chunk currently being shared by the session recorded in the entry one by one or in batches. This session is then eliminated from the donor endpoint table corresponding to these data chunks, respectively.
3. Otherwise, if the request is a “WaitMsg” API request, push a message to the corresponding session through this call (for example, by sending data, returning a response, etc.) as needed.
4. Otherwise, if the request is an “AcquireChunk” API request, then any given rule is used to match this session (requester, donee) to any number of eligible suppliers (donors). And push “Res.Req” messages to these donor endpoints via the “WaitMsg” API.
5. Otherwise, if the request is an “OfferChunk” API request, then update and track the data chunk sharing status of the session in the session table of the owner node of the current session. If this request does declare newly shared data chunks, try to elect to become the owner node of these newly added data chunks or notify its existing owner, and add the current session to their corresponding donor endpoint table respectively.
Conversely, if the request does not contain any new data chunks (ie: all data chunks declared in this request have been shared by the current session), this request is ignored.
6. Otherwise, if the request is a “RevokeChunk” API request, then check, update and track the data chunk sharing status of the session in the session table of the owner node of the current session. If the request has indeed revoked the data chunks being shared by the current session, the respective owner nodes of these newly revoked data chunks will be notified, and the current session will be eliminated from the corresponding donor endpoint table.
Conversely, if the request does not contain shared data chunks (that is, all data chunks declared in this request are not shared by the current session), this request is ignored.
7. Otherwise, if the request is a “p2pOffer” API request, then information such as the donee SID for the request and the resource name is extracted from the request parameters. And push the P2P connection establishment request to the donee through the message push queue (obtained by querying the session table on the donee's session owner) and other components corresponding to the donee's SID and its corresponding “WaitMsg” API and other calls.
8. Otherwise, if the request is a “p2pAnswer” API request, then information such as the donor SID and resource name for which the request is directed is extracted from the request parameters. And push the P2P connection establishment response to the donor through components such as message push queue corresponding to the donor's SID (obtained by querying the session table of the donor session's owner), as well as its corresponding “WaitMsg” API and other calls.
9. Jump back to step 1 (continue processing the next request).
Note: The above process omits error handling and general basic functions that are not directly related to this technical solution, such as authentication, authorization, registration, logout, and logging. The inclusion or absence of these well-known basic general functions does not affect the coverage of this patent.
In addition, the above server clustering logic also omits communication between server nodes. For example, when processing the “OfferChunk” API request, the owner of the current session and the owner of the data chunk to be processed may not be the same server node. At this time, it may be necessary to communicate between different server nodes in the p2pcdn server cluster through message middleware such as BYPSS, BYDMQ (or by means of direct communication, etc.) to forward and/or convey these commands and requests.
These situations are simplified as “execute YY on the owner node of XX”, or other similar forms.
This is because: First, the above-mentioned communication between nodes in a server cluster through message middleware is a well-known basic function and technical common sense, so it is unnecessary to go into details. Second, in a distributed cluster, the outcome of elections is often subject to great uncertainty. If two sessions or two data chunks are arbitrarily selected, whether they happen to belong to the same owner node is essentially a matter of probability (either they may belong to the same owner node, or they may belong to different owner nodes). Even in extreme cases, if there is only one online server node left in the server cluster, then the owner of any online objects including users, sessions, resources, data chunks, etc. will be the only server node (because only this server is left in the cluster at this time).
Therefore, the above description does not particularly emphasize whether the owner of different objects is the same server node, and how to communicate between different servers: These problems are not directly related to the present invention, and do not affect the coverage of the present invention.

### 5.1. Use Case: “Captain China” Play Page

The following takes the browser (Web) playback page (p2p client endpoint) of the video “Captain China” as an example to describe a typical p2pcdn acceleration process. Suppose Tom opens the video playback page of “Captain China”: “https://www.metube.com/2020/Captain China.html”. Then in the play page, the following steps may be performed:
1. When the page is initialized, the “Init” API is called without the SID parameter, and the new session SID returned by the server is saved to the global variable of the current page. At the same time, this SID field is carried in each subsequent request. Below we assume that the SID obtained by Tom this time is “A-000”.
2. Call the “WaitMsg” API to establish a message push channel with keep-alive connection.
3. Suppose Tom requests two resources: the video resource “2020/Captain China.1080p.h264”, and the resource “2020/Captain China.Mandarin.228k.aac” for the audio track. Then Tom initiates the “AcquireChunk” API call to the p2pcdn server for the above two resources respectively.
4. The p2pcdn server successfully matched 48 donors for Tom through ISP and other rules (donors can be understood as Jerry, Mary, John and other people who watched the same video at the same time as Tom). The following assumes that their SIDs are B-001˜B-048, respectively. These 48 donors will receive resource acquisition (p2p networking) requests from Tom (A-000) through their respective “WaitMsg” APIs.
5. Suppose 40 of them (B-001˜B-040) agree to share their resources (data chunks) with A-000. Then these 40 donors respectively call the “p2pOffer” API to send information such as p2p connection offer (the specific content of the SDP Offer is usually generated by methods such as createOffer in the WebRTC component of the browser) and NAT traversal (ICE Conditions) to A-000.
6. Tom (A-000) successfully received the above 40 p2p connection offers through the “WaitMsg” API initiated by him. And call the “p2pAnswer” API, for each received p2p connection offer, return the corresponding p2p connection answer (the specific content of SDP Answer is usually generated by methods such as createAnswer in the WebRTC component of the browser) and NAT traversal (ICE Conditions) and other information.
7. After the donor peers (B-001˜B-040) receive the p2p connection answer sent by Tom through their respective “WaitMsg” APIs, components such as WebRTC can automatically establish a p2p direct connection with A-000 through STUN and other forms. It is assumed that 36 of the donors (B-001˜B-036) successfully established p2p direct connections with the donee (A-000).
8. After the p2p direct connection is successfully established (the p2p subnet is formed), A-000 (Tom) can share and exchange data chunks in the corresponding resources with the donors (B-001˜B-036).
9. Tom checks every second to see if there are newly fetched chunks which can be supplied (for sharing) in the past second. If so, call the “OfferChunk” API to notify the p2pcdn server cluster of “these new data chunks available for sharing” in batches.
Similarly, Tom also checks every second to see if there are old chunks of data that have been flushed out of the buffer in the past second. If so, call the “RevokeChunk” API to notify the p2pcdn server cluster of “these data chunks that cannot be shared” in batches.
If the specified resource is completely removed from the buffer due to the user's request (for example: Tom switches the audio track from Mandarin Chinese to English). Then he should stop sharing all data chunks related to the resource by calling the “RevokeChunk” API.
10. Before exiting the current page or loading new content (e.g.: “Chinese train conductor”) within the SPA page , All shareable resources in the current page should be flushed using the “Init” API bound to the current SID.
The above is a typical “video playback” use case flow. A few points to note are:
   As mentioned above, in most application scenarios, all clients request data chunks one by one in increasing order, and eliminate them from the buffer in ascending order. Therefore, in actual usage scenarios, users do not need to call the “AcquireChunk” API once for each data chunk.
   On the contrary, since the above rules are generally established, users usually only need to use the “AcquireChunk” API at the beginning to find a set of peers (donors) that can provide them with the first (the smallest sequence number, such as data chunk No. 0) required data chunk, and establish a p2p subnet with them. Then there is a high probability that subsequent data chunks (such as No. 1, No. 2, No. 3, etc.) can be successfully obtained through this p2p subnet—We call this mode “freewheeling”.
   Usually, this “gliding” will only fail when the user drags the playback progress bar (jumps the video), switches audio tracks, and other special scenarios. At this point, this method can be called again to start a new “freewheel” process.
   Different p2p network groups should be established for different resources under a page. For example, the video “2020/Captain China.1080p.h264” and the audio track “2020/Captain China.Mandarin.228k.aac” in the above example should have their own LRU buffers and components such as p2p subnets: Each resource stores (caches), shares, and manages its own set of data chunks, and each connects to any number of p2p subnets dedicated to sharing that resource.
   At the same time, multiple p2p subnets can intersect and merge with each other. For example: For session A-000, the roles of B-001˜B-036 are all the donors of the required resource “2020/China Captain.1080p.h264”, but at the same time, A-000 is also a donor of this and/or other resources to endpoints such as B-001˜B-036.
   When the network becomes more complex (for example: A-001 is connected to endpoints such as B-001˜B-018, A-002 is connected to endpoints such as B-019˜B-036), the situation is similar (at this time, for endpoints such as B-001˜B-018, A-000 and A-001 can also be their donors; similarly, for endpoints such as B-019˜B-036, both A-000 and A-002 can be donors).
   A timeout should be set for p2pcdn resource get requests: Once the specified data chunk cannot be obtained through the p2p network within the specified time, a timeout will be triggered. At this point, we can fallback to the traditional solution of obtaining resources from ordinary CDN lines. Of course, resources obtained through traditional methods such as ordinary CDN should also be shared to the p2pcdn network using the “OfferChunk” API.
   In order to speed up the playback of video, audio and other media, we can consider preloading some data before the user clicks the play button; Or consider loading the first few seconds of data at the beginning of each playback directly through traditional means such as ordinary CDN; Or first use a very short timeout (eg 300 ms) to try to obtain the launch data from p2pcdn, and fallback to the traditional CDN method if it times out; Or do both, using both traditional CDN and p2p cdn simultaneously to try to get these data to optimize the user experience, and so on.
   Because the media being played is generally buffered in advance (pre-load) for 60 to 120 seconds during playback. Therefore, after using the above method to optimize the loading of the first few seconds of the video, subsequent data chunks usually have more time to buffer loading gradually, so the loading timeout period can be appropriately extended at this time.
   For example, the video playback page of “Captain China” stipulates that whenever it is detected that the remaining cache memory is less than 90 s, pre-reading is performed again to make up for 120 s. At this time, as long as the required data chunks are obtained within the next 90 s, there will be no problems such as playback freezes.

### 6. Conclusion

To sum up, the present invention divides data into chunks and elects an owner server node for each online data chunk, and then the owner node performs real-time status tracking, statistics, analysis and subnet matching for each data chunk belonging to it. And with “freewheeling” and other technologies, Finally, a reliable, efficient, flexible, strong consistency and high availability p2pcdn system with high performance and high concurrent mass data is realized. The system solves the existing problems such as high traffic costs and limited service capabilities (peak hours or hotspot resources are stuck) in the existing traditional CDN distribution channels.
At the same time, compared with traditional p2p file sharing solutions such as BT and eDonkey, the present invention also has at least the following obvious differences and advantages:
   Different fields are oriented: traditional p2p file sharing solutions such as BT and eDonkey are mainly oriented to sharing static resources such as files, while the present invention is mainly aimed at real-time content sharing scenarios such as audio and video live broadcast and on-demand, video conferences, webinars, and online games.
   Different support functions: traditional p2p file sharing solutions such as BT and eDonkey are mainly for static resources that can be fully accessed (before sharing, you must be able to fully access the entire content of the file to be shared, and then make “seeds” based on it). However, the present invention does not need the above steps, and can perform real-time content distribution for real-time streaming media such as audio and video live broadcasts that cannot obtain complete data in advance, or other similar real-time communication scenarios such as multi-person online conferences and online games.
   Web (browser) and App integration and embedding capabilities: Traditional p2p file sharing solutions such as BT and eDonkey can only be used after installing and deploying special software and/or hardware devices. However, the present invention can be directly embedded in an existing Web page or application, and directly accelerates the existing business logic of the application. For example: directly embedded in the website page of a video website “metube” and its App, to provide p2pcdn services for its existing video-on-demand and live broadcast services, to achieve the beneficial effect of speeding up and reducing costs.
   Full peer-to-peer, no supernodes: Due to the original “data chunk owner election management” algorithm of the present invention, the p2pcdn server cluster can effectively track, count and analyze massive data chunks at the same time, and at the same time provide services to massive online users (sessions), such as the resource matching for massive data chunks and the p2p networking services. Therefore, the present invention does not require special endpoints such as “Super Peer”, “Publisher Peer” or “Seed Peer” with special status in the traditional p2p file sharing scheme. In the present invention, all p2p endpoints have completely equal status (do not belong to each other), and all accept the scheduling and command of the p2pcdn server cluster uniformly, while enjoying the resources (data chunks) contributed (shared) by other endpoints, they also provide (share) the available resources (data chunks) in their own buffers for other endpoints.
   For massive and ultra-high concurrency scenarios where both data and endpoints are unstable:
   Traditional p2p file sharing solutions such as BT and eDonkey are mainly aimed at the environment where the donor and donee nodes are relatively stable. And the p2pcdn server cluster “data chunk owner election management” and other algorithms created by the present invention can better perform distributed real-time routing scheduling for massive endpoints and cache data chunk sets that change drastically at any time.
   For example, the user may close the webpage at any time, drag the playback progress bar greatly to jump, or switch the resolution of the video (such as switching from 720p to 1080p) or the audio track (such as switching from Mandarin Chinese to English), These actions are likely to cause the user (session) previously cached set of data chunks to be completely discarded at the moment the above action is initiated. Or even if the user is just watching the video normally, when the video is played to the 1-hour position, the cache of the 1-minute position is usually eliminated long ago and cannot be shared. The above situation is coupled with the challenges of high-performance real-time tracking, coordination and matching of massive resources and data chunks, and processing ultra-high concurrency scenarios such as hundreds of millions of people watching live online at the same time. These are all problems that traditional p2p file sharing solutions such as BT and eDonkey cannot solve.
   However, the algorithms disclosed in the present invention, such as “data chunking owner election management” for the p2pcdn server cluster, solve the above problems well. Under the premise that the availability of the above data chunks and endpoints is unstable, it can well cope with the application scenarios of massive data and ultra-high concurrency.
To sum up, the present invention overcomes various shortcomings in technical solutions such as traditional CDN and traditional p2p sharing by organically combining the above technical advantages, compared with existing solutions in the industry, it has obvious technical differences and beneficial effects.

1. A peer-to-peer (p2p) content distribution network system based on distributed election, comprising a peer-to-peer content distribution network server cluster; wherein the peer-to-peer content distribution network server cluster includes one or more server nodes; the peer-to-peer content distribution network server cluster divides each resource to be distributed or shared into data chunks, and selects one or more respective owner server node for the data chunks in the peer-to-peer content distribution network server cluster by a way of election, and the data chunk is used as a unit to perform peer-to-peer distribution or sharing of resources.

2. The peer-to-peer content distribution network system based on distributed election according to claim 1, wherein within each peer-to-peer content distribution network server node, a corresponding owner process, owner thread or owner coroutine is elected for each of the data chunks belonging to the server node.

3. The peer-to-peer content distribution network system based on distributed election according to claim 1, wherein the owner node of the data chunk is responsible for tracking, matching and coordinating various states of the data chunk.

4. A peer-to-peer (p2p) content distribution network system based on distributed election, comprising a peer-to-peer content distribution network server cluster and a p2p client network; the peer-to-peer content distribution network server cluster includes one or more server nodes; the p2p client network includes one or more p2p client endpoints that need to use the peer-to-peer content distribution network, and each p2p client endpoint establishes a connection with the p2p server cluster as needed; wherein the peer-to-peer content distribution network server cluster provides API primitives including: subnet matching, sharing data chunks, canceling data chunk sharing.

5. The peer-to-peer content distribution network system based on distributed election according to claim 4, wherein the peer-to-peer content distribution network server cluster also provides the API primitives: an initialization, receiving messages, a P2P connection initiation, a P2P connection response.

6. A distribution method for a peer-to-peer (p2p) content distribution network system based on distributed election, wherein the peer-to-peer content distribution network server cluster processes requests from p2p client endpoints, comprising the steps of:
step 1: waiting and accepting the request sent by a p2p client;
step 2: if the request is an initialization API request, and the API request is not in a valid session context, creating a new session for the request and becoming the owner of the new session through election; if the API request is in a valid session, querying the relevant information of the session in the session's owner node, and notifying all the owner nodes of the data chunks currently being shared by the session to eliminate the session from the relevant records of the corresponding data chunks;
step 3: if the request is a receiving messages API request, pushing a message to the corresponding session through this request as needed;
step 4: if the request is a subnet matching API request, matching zero or more of eligible donors for the current session with zero or more given rule, and pushing the corresponding resource request message to donor endpoints;
step 5: if the request is a sharing data chunks API request, updating and tracking data chunk sharing status of the session on the owner node of the current session, and trying to elect to become the owner node of these data chunks or notify existing owner nodes, to add or update newly added donor endpoint information to the relevant records of these data chunks;
step 6: if the request is a canceling data chunk sharing API request, updating and tracking the data chunk sharing status of the session on the owner node of the current session, and notifying the owner nodes of these data chunks to delete or eliminate the current session from the corresponding donor records of these data chunks;
step 7: jumping back to step 1 and continuing to process a next request.

7. The distribution method for the peer-to-peer content distribution network system based on distributed election according to claim 6, for the p2p client accessing the peer-to-peer content distribution network server cluster, further comprising:
using the initialization API to obtain or reset the session, and establishing a message push connection through the receiving messages API;
for the resources on the current session, using the subnet matching API to request to obtain data chunks sharing from other p2p client endpoints, and/or obtain their data chunks separately through traditional distribution channels;
when receiving a p2p connection request message pushed by the peer-to-peer content distribution network server, trying to establish a p2p connection with specified donee endpoint, wherein after the p2p subnet is successfully established, the donee can directly communicate with each donor endpoint in the subnet and receive the contents of data chunks sent (shared) by the donors;
adding the successfully obtained data chunks to the local cache, and publishing these shares in real time or periodically through the sharing data chunks API;
notifying the peer-to-peer content distribution network server of the data chunks that is no longer shared through the canceling data chunk sharing API in real time or periodically to unshare these data chunks.

8. The distribution method for the peer-to-peer content distribution network system based on distributed election according to claim 6, further comprising
if the request is a P2P connection initiation API request, pushing a specified P2P connection establishment request message to the p2p client endpoint specified in the request;
if the request is a P2P connection response API request, push the specified P2P connection establishment response message to the p2p client endpoint specified in the request;
jumping back to step 1 and continuing to process a next request.

9. The distribution method for the peer-to-peer content distribution network system based on distributed election according to claim 6, for the p2p client accessing the peer-to-peer content distribution network server cluster, further comprising:
using the initialization API to obtain or reset the session, and establishing a message push connection through the receiving messages API;
for the resources on the current session, using the subnet matching API to request to obtain data chunks sharing from other p2p client endpoints, and/or obtain their data chunks separately through traditional distribution channels;
when receiving a p2p connection request message pushed by the peer-to-peer content distribution network server, calling the P2P connection response API to establish the p2p subnet; wherein after the subnet is successfully established, the donee is able to directly communicate with each donor endpoint in the subnet and receive the contents of data chunks sent (shared) by the donors;
adding the successfully obtained data chunks to the local cache, and publishing these shares in real time or periodically through the sharing data chunks API, and establishing p2p subnets via the P2P connection initiation API in order to share them to other p2p client endpoints;
notifying the peer-to-peer content distribution network server of the data chunks that is no longer shared through the canceling data chunk sharing API in real time or periodically to unshare these data chunks;
when receiving the resource request message pushed by the peer-to-peer content distribution network server, trying to establish a p2p connection with the corresponding donee endpoint through the P2P connection initiation API; after the p2p connection is successful, the current p2p client endpoint tries to share requested data chunks with the donee endpoint.

10. The distribution method for a peer-to-peer content distribution network system based on distributed election according to claim 7, wherein after each successful establishment of a p2p subnet, the donee endpoint tries to continue to obtain other adjacent data chunks required from the p2p subnet that has been successfully established.

11. The peer-to-peer content distribution network system based on distributed election according to claim 2, wherein the owner node of the data chunk, or its owner process, owner thread or owner coroutine is responsible for tracking, matching and coordinating various states of the data chunk.

12. The distribution method for a peer-to-peer content distribution network system based on distributed election according to claim 9, wherein after each successful establishment of a p2p subnet, the donee endpoint tries to continue to obtain other adjacent data chunks required from the p2p subnet that has been successfully established.
